(19) United States
(12) Patent Application Publication
(10) Pub. No.: US 2003/0151265 A1
(43) Pub. Date: Aug. 14, 2003

(54) Tool for gripping flowerpots and items of similar shape

(76) Inventor: Peter T. Smith, Peapack, NJ (US)

Correspondence Address: Richard C. Woodbridge, Woodbridge & Associates, P.C., P.O. Box 592, Princeton, NJ, 08542, US

(21) Appl. No.: 10/364,576

(22) Filed: Feb. 10, 2003

Related U.S. Application Data
(60) Provisional application No. 60/356,440, filed on Feb. 12, 2002.

(51) Int. Cl. B65G 7/12

(52) U.S. Cl. 294/16; 294/31.1

(57) ABSTRACT

A tool for gripping the rim of flowerpots, or objects having similar shapes, includes a gripping plate which can swivel 90° from a stowable position to a locked position for use when objects are to be picked up.

### CROSS REFERENCE TO RELATED APPLICATIONS

This application claims the priority of provisional U.S. application serial No. 60/356,440 filed on Feb. 12, 2002 and entitled “ROUND RECEPTACLE TRANSFER TOOL” by Peter Smith, the entire contents and substance of which are hereby incorporated in total by reference.

### BACKGROUND OF THE INVENTION

1. Field of the Invention

The invention comprises a tool, including a pivotable gripping plate, for picking up flowerpots or other objects of similar geometry by their rims.

2. Description of Related Art

There are a number of devices described in the prior art patent literature, and known commercially, that are intended to assist individuals in picking up objects having awkward geometries. In particular, it is especially difficult to pick up heavy objects where there is no suitable handle. Garden flowerpots are typical of this problem because their rims are frequently narrow. Gripping a flowerpot, or any other object having similar rim geometry, poses several difficulties. When an individual repetitiously grasps the rim of a heavy round plant pot with bare hands, fatigue and bodily injury could easily occur. Without using this tool, people are inclined to pick up potted plants by the stem, instead of by the rim of the pot, thus causing damage to the plant. This tool is designed to prevent slippage of the pot, thereby preventing possible damage to both the person and the plant. While the prior art does describe and disclose a few tools for the purpose of picking up awkward objects, nevertheless, there does not appear to be a suitable device that is satisfactory for picking up objects having a rim geometry similar to that of a heavy garden pot.

Perhaps one of the most relevant disclosures is found in U.S. Pat. No. 676,730 entitled Adjustable Jaw Tongs. The adjustable tongs comprise a pivotably related member located directly across from a stationary jaw. The pivotable member is capable of self-alignment with respect to the stationary jaw so that it roughly conforms to the geometry of the item to be picked up. In this particular case, the adjustable jaw is relatively flat so that the item to be picked up has to have a flat corresponding surface.

U.S. Pat. No. 6,240,815 describes a Work Piece Clamping Device which includes clamping blocks which are adjustably rotatable about the axis of their respective mounting posts.

U.S. Pat. No. 1,142,198 describes a similar overall configuration of handles, pivot points, springs, etc. and, likewise, U.S. Pat. No. 2,990,213 describes a pliers-like grasping/holding device for a jar.

The following patents describe container grasping/manipulating devices including a pair of arcuate members which engage the container and, wherein the arcuate members are pivotable relative to the handles to which they are mounted: U.S. Pat. Nos. 600,930; 841,225; 1,212,822; and, 1,282,044.

In addition, the following patents describe pan and pot lifters employing cooperating jaws, one of which includes a mount for a wide arcuate contacting portion: U.S. Pat. Nos. 1,140,781; 1,217,010; 1,330,487; 1,342,758 and 4,078,839.

Lastly, the following patents describe other pot/container grippers of general interest, but probably of lesser relevance: U.S. Pat. Nos. 161,044; 266,382; 280,596; 319,266; 1,118,602; 1,219,726; 1,320,318; and 3,253,850.

In summary, while the prior art describes a number of interesting tools for gripping items, nevertheless, it does not appear to suggest or describe a satisfactory device for lifting a fragile item, such as a flowerpot, by its rim. It was in the context of the foregoing prior art that the present invention arose.

### SUMMARY OF THE INVENTION

Briefly described, the invention comprises a tool to assist in the lifting of heavy objects, such as flowerpots, which have an arcuate rim. The tool includes an arcuately shaped, pivotable gripping plate or means having a shape which roughly conforms to the inside of the rim of a flowerpot. Located across from the pivotable clamping plate is a jaw that includes serrations that can engage the exterior rim of the flowerpot. Squeezing on the handles of the tool causes the gripping plate to move in the direction of the serrated jaw so as to securely grasp the rim of the flowerpot. The flowerpot can then be lifted by pulling up on the handle. When the tool is not being used, the pivotable gripping plate can be swiveled by 90° degrees and stored conveniently in a holster.

The invention may be more fully understood by reference to the following drawings:

### BRIEF DESCRIPTION OF THE DRAWINGS

FIG. 1 is a front perspective view of the transfer gripping tool according to the present invention with the gripping plate shown in its stowed position.

FIG. 2 is a front perspective view of the transfer gripping tool illustrated in FIG. 1 with the gripping plate rotated, or pivoted, 90° to its ready to use position.

FIG. 3 is a left side elevational view of the transfer gripping tool in its ready to use position as seen in FIG. 2, and further illustrating how the offset ledge in the second handle means limits the travel of the first handle means.

FIG. 4 is a left side elevational view of the transfer gripping tool illustrated in FIG. 3 in which the handles have been squeezed to indicate how the two opposing jaws move towards each other.

FIG. 5 is a right side elevational view of the transfer gripping tool as seen in FIG. 3.

FIG. 6 illustrates the transfer gripping tool shown in FIG. 5 in the stowable mode and in a holster for easy caring.

FIG. 7 illustrates the first step in picking up an object, such as a flowerpot, by the rim, in which the tool is brought down over the rim of the flowerpot.

FIG. 8 illustrates the second step in the gripping operation in which the handle of the tool is squeezed causing the two opposite jaws to grab onto the rim of the flowerpot.

FIG. 9 illustrates the third, and final step, of the gripping operation in which the tool is lifted upward, by the user, causing the flowerpot to elevate.

### DETAILED DESCRIPTION OF THE INVENTION

During the course of the description, like numbers will be used to identify like elements according to the different figures which illustrate the invention.

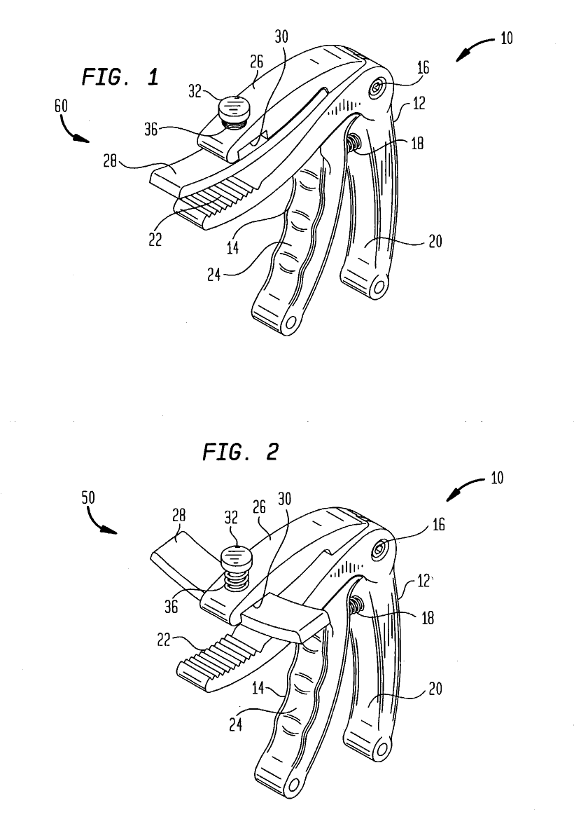

A transfer gripping tool 10, according to the preferred embodiment of the invention, is illustrated in FIG. 1 in its stowable mode 60. The tool is especially useful for the horticultural industry, especially for nursery, landscaping and gardening applications.

The tool 10 is intended to help a user 54 pick up, transfer and place round receptacles having a variety of diameters. Such receptacles might typically comprise flowerpots 100, having rims 102 and lower edges 104 as shown in FIGS. 7, 8 and 9. The purpose of the tool is to (1) alleviate the possibility of fatigue due to repetitious chores involving the hands and forearms, (2) protect the user's hands from cuts and abrasions, (3) make such chores more productive by making the labor involved less strenuous, and (4) to lessen the possibility of damage to the plants inside the round receptacles 100 while they are being moved. While the invention 10 is intended for flowerpots and related receptacles having round or arcuate rims, it is possible that they could be used for grabbing and moving other items of similar geometry.

As shown in FIGS. 1 through 5, the tool 100 includes a first lever arm means 12 connected to a second lever arm means 14 by a pivot section 16. The pivot section 16 includes a bolt and an internal Teflon® or brass bushing. A handle bias spring 18 tends to force the handle section 20 of the first lever arm means 12 away from the handle section 24 of the second lever arm means 14. Squeezing the handles 20 and 24 causes the serrated lower jaw 22 to move towards the gripping plate 28 as it pivots around pivot 16. Gripping plate 28 is connected to the gripping section 26 of the second lever arm means 14 by a bolt 34 which is attached to the gripping plate 28 and passes through a hole or aperture in the gripping section 26. A coil spring 36 surrounds the portion of the bolt that extends through the top of the gripping section 26. Bolt 34 is capped by a knob 32 that holds the resilient spring 36 in position. Gripping plate 28 includes a resilient rubberized pad 38 which improves the gripping capability of the gripping plate 28.

The tool 10 is shown in its ready to use mode 50 in FIG. 2. In the ready to use mode 50, the gripping plate 28 is rotated 90° from the stowable mode 60 as shown in FIG. 1 so that it nests and is received in slot 30 in the gripping section 26 of the second lever arm means 14.

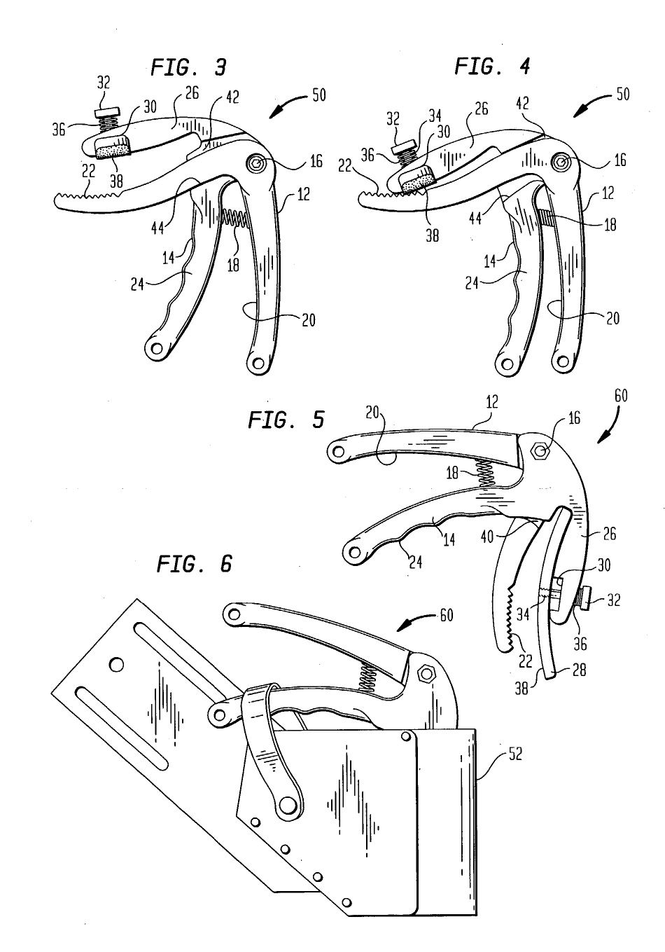

The transfer or gripping tool 10 is shown in a left side elevation view in its ready to use mode 50 in FIG. 3. As seen in FIG. 3, the second lever arm means 14 includes a cut out or offset section 42 having one edge or ledge 44. The lower surface of the serrated jaw 22 normally rests against the ledge 44 under the bias of spring 18 which tends to spread handles 20 and 24. Squeezing on handles 20 and 24 causes the gripping plate 28 to move in the direction of the serrations on the opposing jaw 22 as shown in FIG. 4.

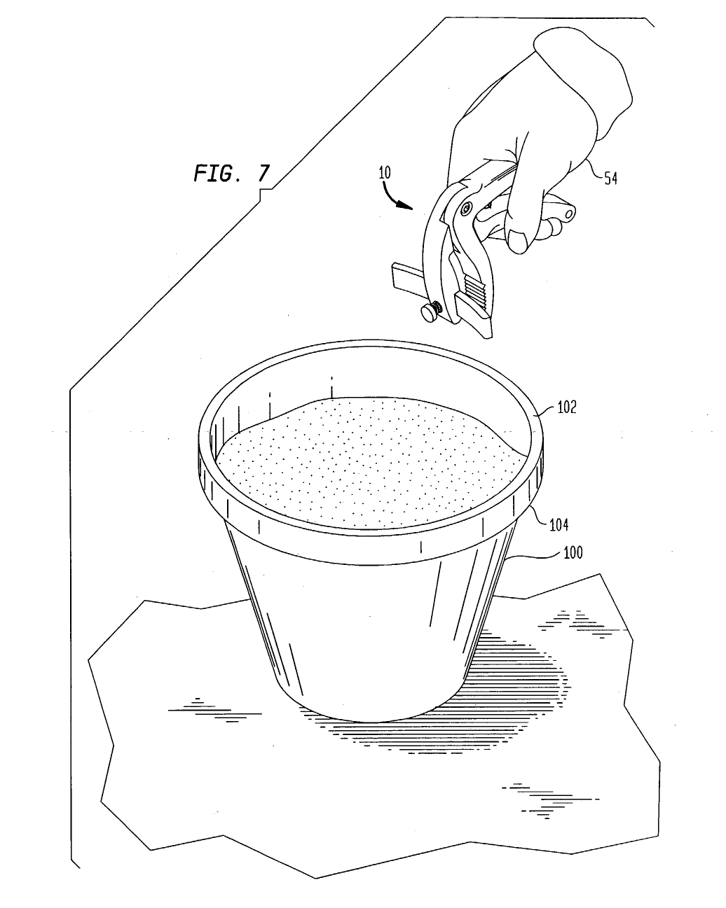

The tool 10, shown in its stowable mode 60, is illustrated from the right hand side. in FIG. 5. In that mode, the complementary cut out or offset 40 in the first lever arm 12 is visible. The offset sections 42 and 44 of the second and first lever arm means 14 and 12, respectively, are in contact with each other in such a fashion that the tool 10 can lie relatively flat in its storable mode 60 and be placed into a holster, or similar carrying device, 52, as shown in FIG. 6.

The invention 10 is used to pick up a flowerpot 100 having an upper rim 102 and a lower edge 104, according to the steps illustrated in FIGS. 7, 8 and 9, respectively.

In FIG. 7, the transfer or gripping tool 10 is shown in its open, ready to use mode 50 as seen, for example, in FIGS. 2 and 3. The gap between the gripping plate 28 and the serrations 22 on the lower jaw are placed roughly above the rim 102 in such a fashion that they can be moved downwardly and around the inner and outer edges of the rim 102.

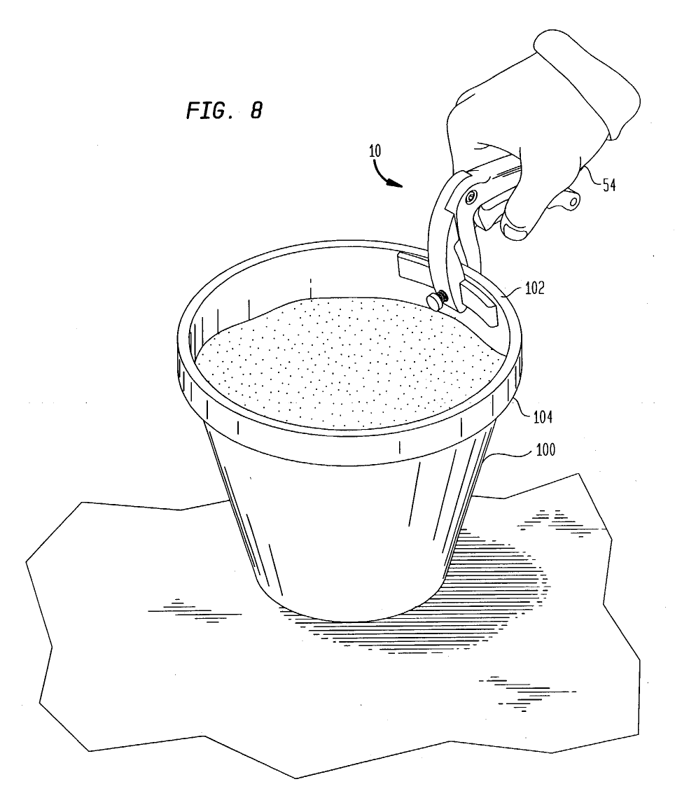

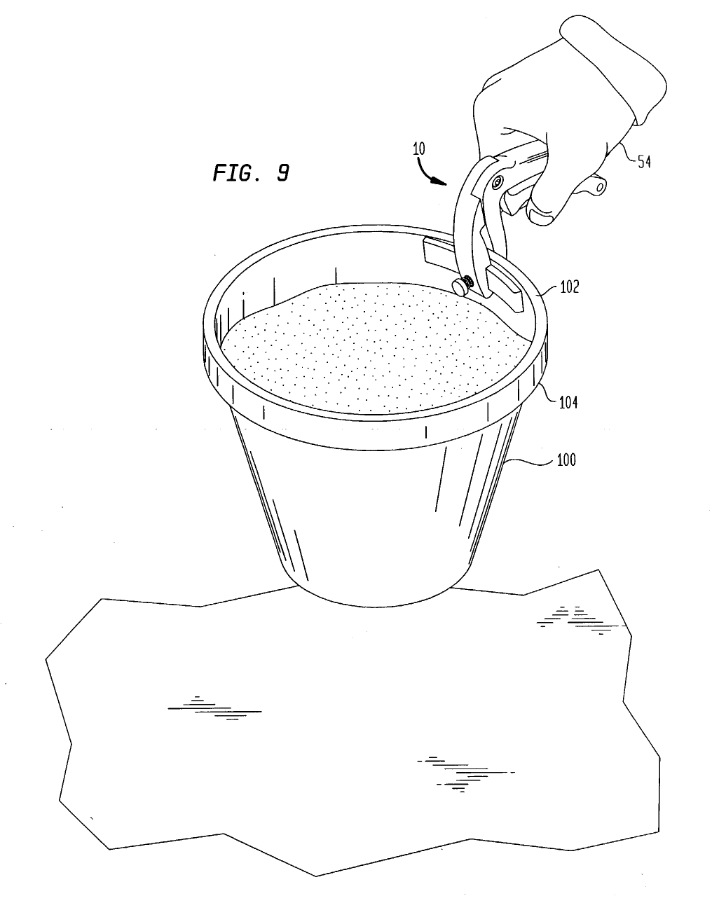

The second step in the gripping process is illustrated in FIG. 8. The user 54 squeezes the handles 20 and 24 against each other thereby causing the gripping plate 28 and the serrations on the lower jaw 22 towards each other, thereby pinching the rim 102 in between both. The serrations 22 on the lower jaw tend to grab onto the lower edge 104 of the rim 102 thereby producing a firm grip on the rim 102.

Third, and lastly, as shown in FIG. 9, the user 54 lifts upwardly with the tool 10 in its gripping mode thereby lifting the pot 100 off of the ground.

The transfer gripping tool 10 is intended to grab round receptacles, or flowerpots, measuring from a 6 inch pliable diameter rim 102 up to and including an empty, light weight 40 inch diameter rim, although no one should or would attempt to pick up a receptacle this large with such a tool 10. Ideally a 10 pound initial weight load is intended and a two-to-one safety factor is built into the tool 10. In addition, the weight load limitation would also be limited by the strength of the user's arm or hand 54.

According to the preferred embodiment of the invention, both sections 12 and 14 of the tool 10 are made of commercial grade aluminum (6061 series) and are held together with a commercial grade plated screw and washer. A Teflon® washer separates the two handles at the joining pivot point 16, which eliminates friction and binding and eases the motion of the tool 10. The handles are preferably coated with a soft, non-slip material to provide comfort and to reduce fatigue for the user 54.

Likewise, the gripping plate 28 is made of commercial grade aluminum (6061 series), and has a radial diameter of 5 inches, and is preferably 4 inches long from tip to tip, but also includes a non-slip strip of resilient material 38 on one side, as previously described, and can minimize any slipping of the receptacle being grasped while the tool is used. The non-slip strip or resilient rubberized pad 38 is commercially available and is adhered to the radial gripping plate, which conforms to any of the original mentioned diameter pots in the range of 6 to 40 inches circumference as measured at the rim 102. Fully assembled, the tool weighs approximately 13.2 ounces and is preferably rust proof. Alternatively, however, the tool 10 could be manufactured of plastic, thereby substantially reducing its weight.

While the invention has been described with reference to the preferred embodiment thereof, it will be appreciated by those of ordinary skill in the art that various modifications can be made to the structure and function of the invention without departing from the spirit and scope of the invention as a whole.

1. A tool apparatus for gripping objects having a circular rim comprising:
a first lever arm means having a handle section, a pivot section and a gripping section;
a second lever arm means having a handle section, a pivot section and a gripping section;
a pivot pin means for pivotally connecting the pivot section of said first lever arm means to said pivot section of said second lever arm means; and,
a gripping plate swivably connected to said gripping section of said second lever arm means;
wherein said gripping plate is swivable from a first stowable position to a ready to use position.

2. The apparatus of claim 1 wherein said gripping plate is curved to approximate the shape of the rim of the object to be picked up.

3. The apparatus of claim 2 further comprising
a spring means connecting said handle sections of said first and second lever arm means for biasing said handle sections away from each other.

4. The apparatus of claim 3 further comprising:
a slot section in said gripping section of said second lever arm means for receiving said gripping plate when said gripping plate is in said ready to use position.

5. The apparatus of claim 4 further comprising:
a bolt means passing through a hole in said slot section and attached at one end to said gripping plate for connecting said gripping plate to said slot section;
a spring surrounding said bolt for biasing said gripping plate into said slot section in said ready to use position; and,
a knob means for contacting said spring and located at the end of said bolt means furthest from said gripping plate.

6. The apparatus of claim 5 wherein said spring is located between said knob means and said slot section.

7. The apparatus of claim 6 further comprising:
the resilient pad means attached to said gripping plate for improving the gripping capability of said gripping plate.

8. The apparatus of claim 7 wherein said second lever arm means includes an offset section having a ledge portion for limiting the travel of said first lever arm means with respect to said second lever arm means under the influence of said spring means between said handle sections.

9. The apparatus of claim 8 wherein the handle sections of said first and second lever arm means respectively are bent at approximately 90 degrees with respect to the gripping sections thereof.

10. The apparatus of claim 9 further comprising:
a holster for storing said apparatus when said apparatus is in said stowable position.

11. The apparatus of claim 10 wherein said object to be gripped comprises a flowerpot
